(19) United States
(12) Patent Application Publication
(10) Pub. No.: US 2005/0128732 A1
(43) Pub. Date: Jun. 16, 2005

(54) Luminous device

(76) Inventor: Marc Potthoff, Rosrath (DE)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/795,575

(22) Filed: Mar. 8, 2004

(30) Foreign Application Priority Data
Mar. 7, 2003 (DE) 203 03 618.2
Apr. 29, 2003 (DE) 203 06 598.0
Jul. 26, 2003 (DE) 203 11 556.2

(51) Int. Cl. G01D 11/28; F21V 5/00

(52) U.S. Cl. 362/23

(57) ABSTRACT

The luminous device comprises a body made of light-conducting material having a base surface and adjacent side surfaces which enclose an angle relative to the base surface, where at least one LED is located in the body, the main angle of light radiation of which encloses a larger angle relative to the base surface than to the side surfaces so that the light emitted by the LED is propagated in the body and emerges from the body on at least one side surface. The LED is located in a receptacle worked into at least one side surface of the body and is accommodated completely by the body.

The invention relates to a luminous device with a body made of light-conducting material, with a narrow base surface and adjacent, large-area, essentially plane-parallel side surfaces that enclose an angle relative to the base surface, where at least one LED is located in the body, the main angle of light radiation of which encloses a larger angle relative to the base surface than to the side surfaces adjacent to the base surface of the body.

Luminous devices of this kind are known and are used, for example, as information and/or advertising displays, or as decorative objects. In most luminous devices of this kind, a separate holder for the LEDs is provided, being located on a narrow side of the body. This design is complicated, increases the size of the luminous device, and causes problems in relation to service life if the luminous device is to be used for outdoor applications and thus exposed to the weather.

The object of the invention is to create a generic luminous device with LEDs, which can be manufactured easily and inexpensively, and which, where appropriate, also displays a long service life when used for outdoor applications.

According to the invention, this object is solved by a luminous device in which the at least one LED is located completely in a receiving area of the body and where a groove is incorporated in one, large-area side surface of the body, in which the at least one LED is located.

In this way, the LEDs are completely protected by the body, and a separate holder for the LEDs can be dispensed with. Also, the particularly sensitive connecting areas of the LEDs can be located in the body in simple fashion. The body also displays a groove for accommodating supply leads or for connecting two or more LEDs to each other, where the LED receiving area and the connecting groove can be located in the large-area side surface and/or the base surface of the body. Regardless of its location, the connecting groove can extend over part or all of the circumference of the body. The large-area side surfaces are preferably plane-parallel, or enclose a small angle of preferably less than 20°.

The incorporation of a laterally open groove in a body is, for example, easily accomplished by milling or by other material-removing processes, even if the arrangement comprises a plurality of LEDs. Furthermore, the side surface with the open groove can be located opposite the side surface of the body that is most severely exposed to the weather.

The main direction of light radiation of the at least one LED, or of all LEDs, can enclose an angle of 45° to 135°, preferably 60° to 120°, particularly preferably essentially 90°, relative to the base surface, and enclose a smaller angle relative to the side surfaces adjacent to said base surface, preferably less than 60°, for example, or less than 15° to 30°, or it can preferably lie essentially parallel to at least one, or both, of the large-area side surfaces. The side surfaces adjacent to the base surface can follow on directly from the base surface, or they can be separated from it by transitional areas. They essentially define the shape of the body. Independently of each other, the base surface and at least one, or all, of the side surfaces can be of plane, curved, textured or other design. Depending on the field of application, 1, 2 or more LEDs, e.g. 10 or more LEDs, can be located in the body. The base surface can, in particular, be characterized by the above-defined angle relative to the main direction of light radiation of the at least one LED, where the base surface usually displays a smaller area than at least one, or all, of the side surfaces of the body. The base surface can, in particular, be defined as the surface that faces the base of at least one LED, or all LEDs.

The at least one LED, or several or all LEDs, can be SMD LEDs or conventional LEDs with a diameter of several millimeters, e.g. in the range of 2 to 6 mm, e.g. 4 mm, without being limited to this.

The body made of light-conducting material, which can be transparent or colored, but can also display a certain degree of intrinsic light scattering, preferably consists of a plastic material, e.g. polymethyl methacrylate (Plexiglas), acrylic plastic, Makrolon (Bayer trademark) or the like, preferably one with the highest possible refractive index, without being limited to this.

Alternatively or additionally, a groove for accommodating one or more LEDs can also be incorporated in a face end of the body, such as the base surface.

The groove, or the receiving area in general, preferably receives the at least one LED without any undercut, so that the LED can simply be laterally inserted into the body.

The groove, which can be incorporated in a side surface or a face end of the body, can, in particular, extend essentially parallel to a bordering edge of the body, or the bordering edge closest to the groove, although it can also assume any other suitable position. The respective groove can be adapted to accommodate solely one LED, meaning that a plurality of grooves is provided on the body in the event of an arrangement with a plurality of LEDs, although several LEDs can also be arranged in one groove. Regardless of the number of LEDs per groove, the main direction of light radiation of the LEDs in the direction towards one of the groove sides or the groove base can enclose an angle of 35° to 145°, without being limited to this, preferably 60° to 120° or 70° to 100°, or preferably be positioned essentially perpendicular to a groove side or the groove base. In this context, the groove length can essentially correspond to the LED length, where the LEDs can be arranged laterally to the groove base. If several LEDs are arranged in a groove, the groove width can essentially correspond to the LED length.

The groove accommodating the LED is preferably a distance away from all limiting edges of the body and thus open only towards one or both large-area side surfaces of the body.

The receiving areas of the LEDs can be separated from each other by wall areas, which can essentially be designed in the manner of webs and preferably extend over the entire height of the groove. The wall areas can be worked from the body material.

The groove-shaped connecting area for accommodating supply leads can extend over a plurality of LED receiving areas, preferably extending in essentially linear or parallel fashion relative to a limiting edge of the body, such as the nearest limiting edge. The LED receiving areas can lead off laterally from the connecting groove and extend from there over at least the LED length, although a partial area of the LEDs can also be located in the connecting grooves. The connecting grooves extend in a direction transverse, preferably perpendicular, to the main direction of light radiation of the LEDs.

Particularly for accommodating a power supply, such as batteries, storage batteries or the like, or other electrical or electronic supply or operating devices, a laterally open receiving area for at least one LED can lead into an area that is laterally open, i.e. towards a large-area side surface, has an enlarged cross-section compared to the receiving area and faces the base side of the LEDs. The different receiving areas or enlarged areas can, in particular, be designed in the manner of a stepped hole, where one or more openings or holes lead off from a first hole with an enlarged cross-section for accommodating the power supply. The LED receiving area and the enlarged area preferably display parallel or congruent longitudinal axes.

The body can be of panel-like design, i.e. have two, large-area side surfaces that are arranged essentially plane-parallel to each other and limited by narrow sides whose width is a small fraction of the width of the large surfaces. In this context, the groove-shaped LED receiving areas and/or the groove-shaped connecting areas are incorporated in one of the large-area side surfaces, the main direction of light radiation of the LEDs lying, for example, in a range of angles from −45° to +45°, −30° to +30°, relative to the side surfaces, preferably essentially parallel to the large side surfaces.

The groove-shaped LED receiving and connecting areas are preferably located on a large-area side surface adjacent to the base surface of the body.

In the case of a panel-like design of the body, the panel thickness can be less than/equal to three times, less than/equal to two times, or less than/equal to 1.5 times the LED diameter, without being limited to this.

If one of the side surfaces of the body is provided with a roughened area that is illuminated by the at least one LED, the light-emitting area of at least one, or all, of the LEDs can be located at the level of the roughened area, preferably the entire LED in each case.

At least one, or all, of the narrow surfaces and, where appropriate, also the large-area side surface opposite the viewing surface of the body can be partly or completely roughened, this greatly simplifying the manufacture of the luminous devices because transitions between roughened and non-roughened areas can be avoided, or do not appear on the viewing surface of the body.

Roughening can be achieved by etching, sand-blasting, brushing or any other suitable method, and it can be performed superficially or by making deep impressions.

It goes without saying that, in all embodiments of the luminous device, at least one circuit board for supplying power to the LEDs can be provided, where the circuit board can be integrated in the body, preferably within the receptacle accommodating the power source. The circuit board, which may also bear other electronic components, and the power source can be integrated in an insert.

The body can display several LEDs that emit light of different colors, where LEDs of different colors can preferably be operated independently of each other.

Preferably, means are provided, by means of which an operating parameter for an LED group can be controlled during operation of another LED group. The means can be assigned to the luminous device or integrated in it.

Circuit boards that are assigned to the LEDs, and which are provided with electrical devices required for operating the LEDs, are preferably located in the receptacle accommodating the power supply.

The body is preferably of one-piece design.

According to a further, preferred embodiment, the body of light-conducting material can display an insert, which is essentially of panel-like design. The insert can be fixed in a recess or an opening of the body, for example by being retained by a press fit or by being bonded. Further, the insert can display one or more outwardly protruding projections, or a surrounding edge protruding radially outwards that engages a corresponding recess in the body. The body recess can, for example, be designed as a surrounding stepped shoulder. In this context, the insert is inserted in an opening in a large-area side surface of the body.

The insert preferably lies flush with a first, large-area side surface of the body, and preferably also with the opposite side surface of the body.

The insert preferably displays a depression for accommodating a power source, such as a battery or a storage battery, for operating the at least one LED of the luminous device. Further, the insert accommodates a push-button element, preferably in the form of a plate-like push button, that is located on the outside relative to the power source and seals off the insert towards the outside. Where appropriate, the push-button element can be covered by a film extending over the entire insert or, preferably, over the entire side surface of the luminous device. Further, the insert can display at least one or more recesses that open radially towards the outside for accommodating an LED, preferably an SMD LED. In this context, the LED, particularly the SMD LED, is preferably located entirely inside the insert. As a result, the insert can, together with the LED and the power source, be fixed on the body or dismantled from the body of the luminous device for replacement of the power source or the LED. The receiving opening for the LED can, in particular, be designed in the form of a blind hole, and the receptacle for the LED can also be open towards at least one surface of the body of the luminous device, particularly towards one large-area side surface. The LED is preferably retained by the insert on both sides in the circumferential direction of the insert. The insert can also accommodate a circuit board for operation of the LED.

The base surfaces surrounding the body preferably display no opening of any kind, meaning that the body is closed over the entire circumference and only displays recesses in the large-area side surfaces.

An example of the invention is described below and explained on the basis of the Figures. The Figures show the following:

FIG. 1 A schematic representation of a first luminous device according to the invention,

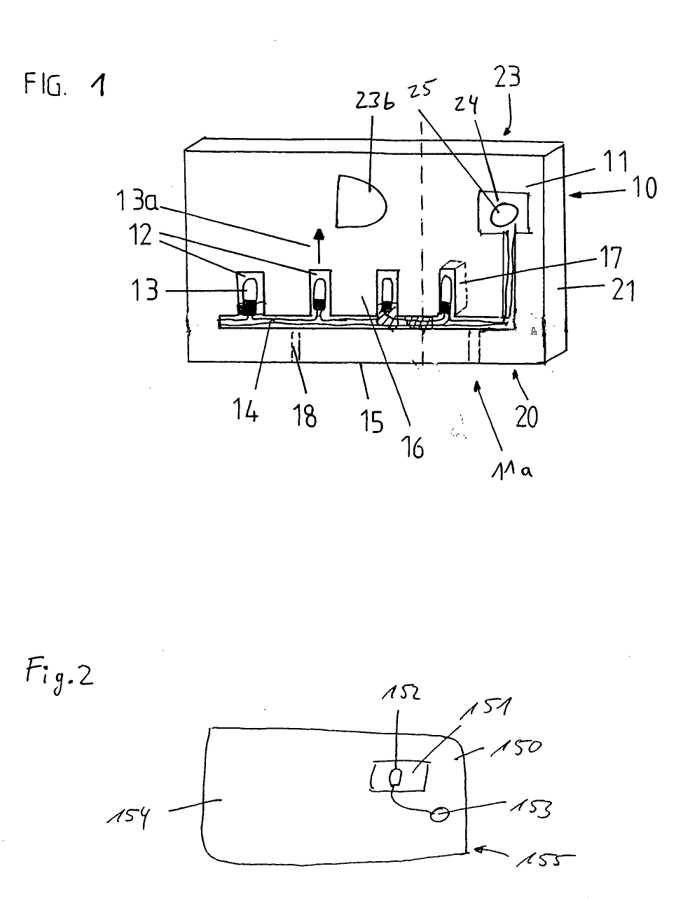

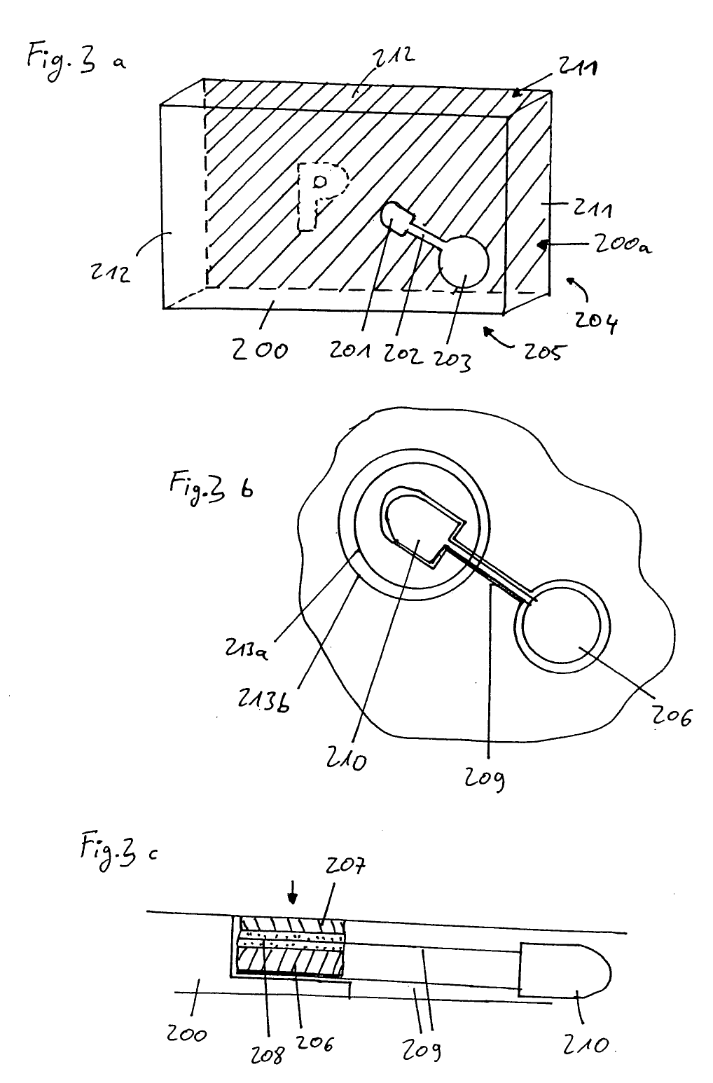

FIG. 2 A schematic representation of a further luminous device according to the invention,

FIG. 3 A perspective view of a further embodiment of a luminous device (FIG. 3a), as well as a top view of a detail of the luminous device (FIG. 3b and a sectional representation (FIG. 3c),

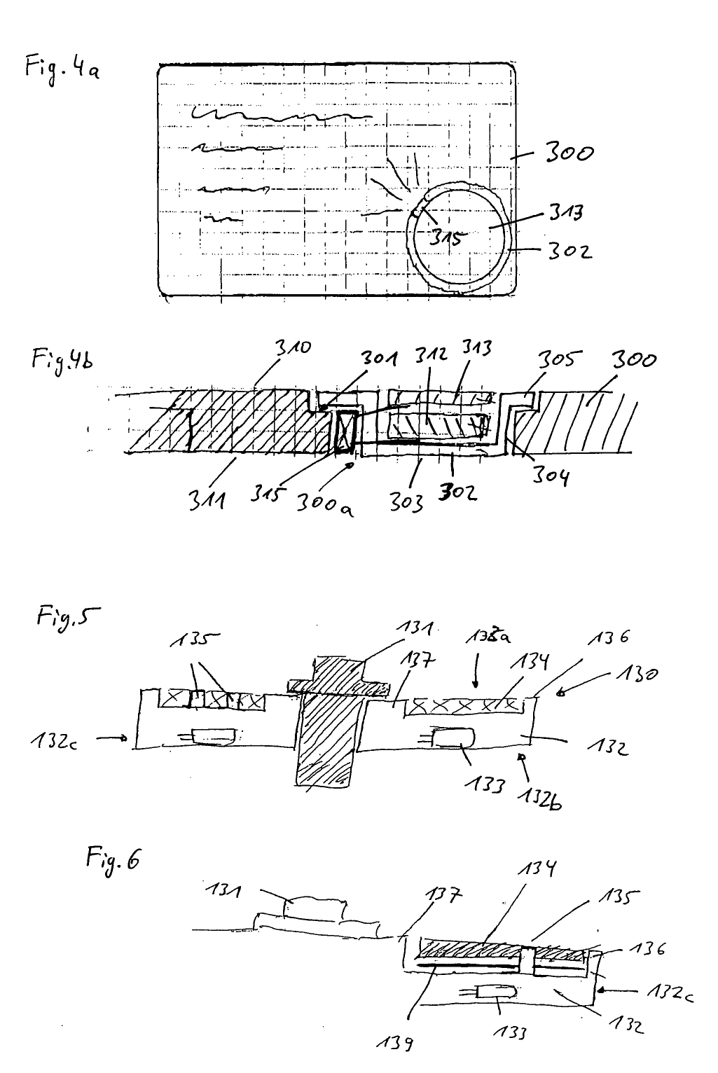

FIG. 4 A schematic representation of a further embodiment of a luminous device according to the invention, in a top view (FIG. 4a) and a sectional view (FIG. 4b),

FIG. 5 A sectional view of a further embodiment of a luminous device according to the invention,

FIG. 6 A sectional view of a modification of a luminous device according to FIG. 5.

FIG. 1 shows a panel-like body 10 with opposite, essentially plane-parallel, large-area side surfaces 11 and a base surface 11a enclosed by them, where several receiving areas 12 for LEDs 13 are milled into one of the side surfaces, the main direction of light radiation 13a of the LEDs being oriented perpendicular to a partial area of the base surface of the body, the base surface of the body being of plane design in this instance. The LEDs are located entirely in the receiving areas, and the receiving areas are connected by groove-like connecting areas 14 for accommodating supply leads for the LEDs, where the longitudinal axis of the LED receiving areas is arranged perpendicular to the longitudinal direction of the connecting grooves. Further, the connecting areas extend parallel to limiting edge 15 of the body. The depth of the connecting areas can correspond to the depth of the receiving areas, or be such that it essentially ends at the level of the outgoing leads of the supply leads from the LEDs, meaning that the outgoing LED leads can be placed directly on the base of the groove of the connecting areas in order to prevent damage. The LED receiving areas are designed in the manner of pockets and separated from each other by wall areas 16, which are worked from the body. Both the connecting necting areas and the receiving areas are without undercuts, so that the LEDs and supply leads can be inserted easily, although undercuts can also be provided, where appropriate.

Further, groove sides 17 of the receiving areas and the connecting areas lie perpendicular to the principal plane of the body, which can also be the case in the event of side surfaces with a bent, curved or other kind of profile, regardless of the panel-like shape of the body.

Side surface 23 of the body, which is to be positioned in the direction of view and can be opposite to the side surface provided with the grooves, displays an area 23b, roughened by sand-blasting, which displays the form of a symbol (letter, figure, logo or the like) and which is illuminated far more strongly by the LED light than the adjacent, smooth areas of the side surface.

The groove accommodating the outgoing LED leads transitions into receptacle 24, which is open towards the same side surface and has an enlarged opening area located in the side surface, in which the power source, such as a battery, can be located. This receptacle can be sealed off towards the outside by a push button 25 for operating the battery.

FIG. 2 shows a luminous device as a small-format information card 150 in the form of a business card with information field 151, in which LED 152 is located, which is supplied by a power supply in the form of button cell 153. It goes without saying. that the LED and the information field can also be arranged in a laterally offset position relative to each other. The LED and the button cell can be located in recesses that are open preferably towards the rear side or, where appropriate, also towards a narrow side or towards the front viewing surface. Where appropriate, the LED and the power supply can be enclosed in, e.g. molded into, the information card, which consists of a plastic material, for example. Apart from information field 151, the remainder of front side 154 or, in addition, the rear side can serve as an information field. The area illuminated by the LED can be restricted to information field 151, to which end suitable opaque borders, such as opaque films, can be provided on the narrow sides of the information field, and front side 154 can also be provided with an opaque or semi-transparent coating. Where appropriate, the light emitted by LED 152 can emerge at narrow sides 155 of the information card, or the narrow sides can be coated with an opaque material. Similarly, the rear side, and also one or more of the other bordering sides of the card, can be partly or completely coated with a semi-transparent or opaque material. As a result, the information card as a whole can be designed in diverse ways, where different areas of the information card can be optically emphasized by illumination by one or more LEDs integrated in the card, or illuminated to improve legibility in the dark.

FIGS. 3a-c show a further embodiment of a luminous device according to the invention, which can particularly be designed as an information carrier, especially as a small-format information carrier, such as a business card. It goes without saying, however, that numerous other fields of application also exist and that the luminous device can, where appropriate, also not be provided with information. According to the practical example, body 200 is of flat or panel-like design in the form of a plate, where narrow side 200a, facing the LED base, can be taken to be the base surface of the body, although the body can also be of cylindrical, more isometric or another form. The body displays LED receptacle 201 and receptacle 202 for the outgoing LED leads, both of which are in this case open towards opposite surfaces of the body, preferably towards surfaces with a short distance between them. Where appropriate, it is also possible for only receptacle 201 or only receptacle 202 to be open on both sides. According to the practical example, receptacles 201 and 202 are open towards opposite, large-area side surfaces 204, 205. Receptacles 201, 202 are thus open towards the same side surfaces of the body. Where appropriate, and given a suitable shape of the body, opening towards other side surfaces may also be practicable, or receptacles 201 and 202 can be open towards different surfaces of the body on both sides. Receptacles 201 and/or 202 are open towards the two side surfaces over the full extent of their cross-section running parallel to the side surfaces, meaning that the receptacles are designed without undercuts towards the side surfaces. Where appropriate, receptacles 201 and/or 202 can also display undercuts in the direction of side surfaces 204, 205, said undercuts lying flush with the top side of the body, for example. The lateral width of receptacles 201, 202 for the LED and its out-going leads is dimensioned such that they laterally surround the components to be accommodated with only slight play, which is sufficient, in particular, for simple assembly without damage, or virtually without play. Since the receptacles extend through the body without undercuts, they are easy to manufacture in terms of production engineering, e.g. by producing through cuts of predetermined width by milling, laser cutting or the like. Where appropriate, one or both of receptacles 201, 202 can be open towards only one side surface, particularly a large-area side surface, in the manner of a groove.

Receptacle 202 leads into a receptacle, preferably open on only one side, for an LED power source, such as a button cell. The receptacle is preferably open towards front side surface 205, i.e. the surface facing the observer, where the opening can be partly or completely sealed off by pressure plate 207, manual operation of which permits switching of the LED. Pressure plate 207 is designed in a color different from that of the body, this facilitating its handling. The color of the pressure plate can correspond to the color of the LED. In this context, the receptacle for the LED power source is located in such a way that the principal plane of the power source runs parallel to the principal plane of the luminous device.

In this instance, the receptacle for the LED power source is located in a corner area of the luminous device. However, the LED power source can also be located in the area of an outer edge of the luminous device, or at another suitable point.

The main direction of light radiation of the LED and/or the longitudinal extension of the outgoing LED leads is preferably oriented roughly towards the center of the luminous device, without being limited to this, where the main direction of light radiation can be located parallel to side surfaces 204, 205. Pressure plate 207 fits almost exactly into power source receptacle 203, and is separated from power source 206 by flexible material, such as foam pad 208, where the flexible material can also be dispensed with under certain circumstances. Pressure plate 207 is moreover connected, preferably directly, to one of outgoing LED leads 209, so that the exertion of manual pressure on the pressure plate (see arrow) indirectly, or preferably directly, establishes contact between the outgoing LED line assigned to it and the power source for operating the LED by closing a circuit. In this context, the outgoing LED leads can, where appropriate, themselves exert the necessary restoring force to move the pressure plate into its neutral position, or this force can also be exerted solely or additionally by the flexible material. The power source is securely retained in the receptacle by suitable measures to prevent axial and lateral displacement. The respective connecting points of power source and body, outgoing LED line and pressure plate, power source or flexible material and pressure plate and the like can, for example, be made by bonding, e.g. using double-sided adhesive tape or other adhesives. Where appropriate, pressure plate 207 can also be connected to the near outgoing LED lead in unchanging position and in a manner permitting a change of position relative to the distant outgoing LED lead. Where appropriate, switches of different design can also be provided.

Instead of, or in addition to, the at least one LED 210, the luminous device can be provided with luminescent film 211 (FIG. 3a, shaded), which preferably extends partly or entirely over rear side surface 204, facing away from the observer, although it can alternatively or additionally extend over one or more of narrow sides 212 and/or front side surface 205. The luminescent film is connected to the power source by suitable contacts (not shown) and can be actuated by operating pressure plate 207 or a different operating device, then emitting luminescent light. The luminous body provided with a luminescent film can likewise be provided with information, preferably symbols engraved in rear side surface 204, which can be covered by the luminescent film on the rear, although the luminescent film can also extend only over the part of the luminous body not provided with information. It goes without saying that, instead of the luminescent film, it is also possible to use other luminescent means, such as appropriately applied layers of luminescent material.

Further, when using an LED and/or a luminescent film, the luminous device can be provided with a partly or completely mirror-finished surface 213, which can also be semi-transparent. This mirror surface 213a, 213b can, in particular, be located at the level of the LED on the side facing towards and/or away from the observer, or it can extend partly or completely over rear side surface 204. Where appropriate, one or more of narrow sides 212 can also have a mirror finish. The luminous efficacy in certain directions of light radiation, e.g. towards the observer, can be increased in this way. The mirror finish can be obtained by means of a reflective foil, by vapor-plating the body surfaces with a reflective material, or in any other suitable manner.

FIGS. 4a, 4b show a further embodiment of the luminous device according to the invention as a small-format information carrier, particularly in the form of a business card. One-piece body 300, made of transparent material such as acrylic glass, displays through opening 300a with stepped shoulder 301, where an insert 302 is located in the through opening. Insert 302 is essentially of pot-shaped design, with a bottom area 303, an upturned edge 304 and a radially projecting area 305, which is likewise designed as a radially surrounding edge. Radially protruding area 305 reaches over stepped shoulder 301 of the body, the stepped shoulder likewise being of radially surrounding design. The upper side of radially surrounding edge 305 and the underside of the bottom area each end flush with associated large-area side surfaces 310, 311 of the body. The insert can, in particular, be fixed in the body by means of a press fit.

The insert accommodates a battery 312, a push-button element 313 and at least one LED 315, particularly an SMD LED. The main direction of light radiation of LED 315 is selected such that a significant portion, preferably the greater portion, of the light emitted by the LED falls into the body. To this end, the main direction of light radiation of the LED can, in particular, be located parallel to the principal plane of the body made of transparent material. The insert surrounds the LED on both sides in the circumferential direction of the insert. In this context, the LED is, as is also the case in the practical example according to FIGS. 3a-c, in contact with the power source (battery) via one outgoing electrical lead, the other outgoing lead being connected to the push-button element and capable of likewise being brought into contact with the battery by pressing down said push-button element, where the LED can also be designed to be supplied with power by the battery in a different manner.

One or both of the large-area side surfaces of the body, particularly the side surface facing the push-button element, can display roughened areas designed in the form of a symbol, so that the roughened areas are illuminated by the light emitted by the at least one LED, so that the illuminated symbol can be perceived in illuminated state by pressing the push-button element. Information can also be provided in a different manner, for example in the form of semi-transparent, e.g. colored, or opaque coverings on the side surfaces, e.g. in the form of printed areas applied by screen printing, for example, adhesive films or the like.

The main direction of light radiation of the LED is preferably oriented roughly towards the center of body 200.

FIG. 5 shows a luminous device as an instrument control panel, specifically as a bell button 130 with a push-button device 131 for switching, in the customary manner, an electrical circuit assigned to a bell, where it goes without saying that any other electrical device can also be assigned to the push-button device. In this instance, the push-button device is designed in the form of a push button, although it can also be designed in any other suitable manner, e.g. as a toggle switch, a momentary-contact switch or the like. The push-button device is mounted on body 132 in this context. To make the push button easily recognizable, even in poor lighting conditions, or to be able to distinguish between different push-buttons according to their functions, at least one or, for example, two opposite LEDs 133 are located in body 132, which is made of light-conducting material, such as Plexiglas. A cover 134, which can be transparent, semi-transparent or opaque to the light emitted by the LEDs, is provided above the LEDs in the viewing direction. The cover can, for example, likewise be made of Plexiglas. The cover can be colored. The cover is preferably located above the LEDs in the viewing direction, although it can, where appropriate, also be offset in relation to them. Cover 134 only partly covers face 132a of the body and, according to the practical example, leaves a radially outward-lying edge 136 and a radially inward-lying edge 137, where the light emitted by the LEDs emerges at edges 136, 137 on the face of the body and, moreover, can enter cover 134 on account of reflections within the body, provided that the latter is opaque, such that, furthermore, cover 134 appears illuminated towards the face of the body facing the observer. It goes without saying that, where appropriate, the areas of the face of the body other than cover 134, such as edges 136 and/or 137, can also be provided with a partially transparent or opaque cover, so that, for example, light only emerges from the body via the face of cover 134 in the direction of an observer.

According to the practical example, LEDs 133 are located flat, i.e. parallel to rear face 132b of the body, in body 132, which is designed as a flat plate, meaning that area 132c of the body, which faces the base of the LEDs, can be interpreted as being the base surface of the body.

Further, cover 134 displays open areas that are engaged by elevated areas 135 of the body, where areas 135 preferably fill the openings completely in the extension of face 132a of the body, and preferably end at the level of face 132a. Elevated areas 135 can be designed in the manner of a symbol, such as a letter or a set of characters, e.g. a name, for instance if the bell button is to serve as a door nameplate at the same time. The same applies to other applications.

FIG. 6 shows a modification of the instrument control panel according to FIG. 5, which is likewise designed as a bell button, where identical characteristics are identified by the same reference numbers. Supplementary to the practical example according to FIG. 5, a light-attenuating or opaque additional cover 139 is provided between body 132 and cover 134, being located above LEDs 133 in the viewing direction. This prevents uneven distribution of the brightness in the area of the body or cover 135 located above the LEDs, which could appear in the form of a spot of light of the LED. It goes without saying that the opacity of cover 139 can be greater, or much greater, than that of outer cover 134, where cover 134 can be provided merely for decorative and/or informative purposes. Even in case of opacity of cover 139, which faces the LED, light can enter cover 134 from one of more side surfaces 134a. Cover 134 is preferably of plate-like design. Also according to this practical example, covers 134 and 139 can be provided with openings that are partly, or preferably completely, filled, preferably by elevated areas 135 of the body, e.g. in order to provide symbols, lettering or other information. Covers 135 and 139 are preferably of congruent design in reference to face 132a of the body.

It goes without saying that, as a result of a flat arrangement of the LEDs, the instrument control panel can display a very low overall height, although the LEDs can, where appropriate, also be arranged such that their main direction of light radiation is perpendicular to the face of the body.

1. Luminous device with a body made of light-conducting material, with a base surface and adjacent side surfaces, which are of large area compared to the base surface and enclose an angle relative to the base surface, where at least one LED is located in the body, the main angle of light radiation of which preferably encloses a larger angle relative to the base surface than to the side surfaces adjacent to the base surface of the body, where the LED is located in the body in such a way that its main direction of light radiation is essentially parallel to the side surfaces and the light emitted by the LED is propagated in the body and emerges from the body on at least one side surface, characterized in that the LED is located in a receptacle worked into at least one side surface of the body and in that the LED is accommodated completely by the body.

2. Luminous device according to claim 1, characterized in that the receptacle accommodating the LED is designed as a groove, and a power supply assigned to the LED is located in an adjacent receptacle that is connected to the groove accommodating the LED by a connecting groove.

3. Luminous device according to claim 1, characterized in that a groove with several receiving areas for at least one LED each is incorporated in one side surface of the body, and in that the receiving areas are connected by at least one groove-like connecting area for accommodating supply leads for the LEDs that is open towards the same side surface.

4. Luminous device according to claim 1, characterized in that the LED is designed as an SMD LED, which is fastened to an insert that accommodates the power supply for the LED and is located in the receptacle in the side surface.

5. Luminous device according to claim 1, characterized in that the body displays an LED receptacle that is designed to be open towards two, opposite side surfaces, or displays a receptacle for outgoing LED leads that is open towards two, opposite sides of the body, or displays a receptacle for an LED power source, which is incorporated in the body and open towards two, opposite sides.

6. Luminous device according to claim 1, characterized in that the LED receptacle, or the receptacle for the outgoing LED leads, is designed to be open towards both side surfaces, and in that the LED power source receptacle is designed to be open only towards one side surface.

7. Luminous device according to claim 1, characterized in that, in addition to the at least one LED, a luminescent device is provided in the form of a film that covers at least part of a side surface and can be excited to produce luminescence by at least one power source integrated in the body.

8. Luminous device according to claim 1, characterized in that an LED power source is integrated in the body.

9. Luminous device according to claim 1, characterized in that a manually operated pressure plate for operating the respectively assigned LED is provided, which at least partly seals off a receiving opening for the LED power source.

10. Luminous device according to claim 1, characterized in that the body displays an insert that can be fixed in the body, where the insert displays at least one LED, a power supply for the LED and a push-button element, these being electrically connected to each other in such a way that the LED emits light when the push-button element is operated.

11. Luminous device according to claim 10, characterized in that the insert is inserted in a recess, which is open towards at least one large-area side surface of the body, and ends flush with at least one, or both, of the large-area side surfaces of the body.

12. Luminous device as a small-format information card in the form of a business card designed to fit a wallet, a post-card or a menu.

13. Luminous device according to claim 1, as an instrument control panel, where the light-conducting body is designed as a base plate of the panel that bears a push button, where the push button is provided with electrical connections for electrically conductive connection to an electrical device.

14. Luminous device according to claim 13, characterized in that the body displays a cover that covers the at least one LED, at least attenuates the light, and covers the body only partly towards one large-area side surface.

15. Luminous device according to claim 14, characterized in that the cover does not completely cover the body towards the front side in the area of the outer edge and/or in the area of the push button.

16. Luminous device according to claim 13, characterized in that, referred to the LED, a second, essentially transparent cover is provided above the at least light-attenuating cover, this being at least roughly congruent to the at least light-attenuating cover, and located in such a way relative to the body that light emitted by the at least one LED enters the second, essentially transparent cover and emerges on one side surface of the luminous device.

17. Luminous device according to claim 13, characterized in that the first, light-attenuating cover displays through openings that are penetrated by light-conducting material that is connected to the body in light-conducting fashion, or is part thereof.
